(19) United States
(12) Patent Application Publication
(10) Pub. No.: US 2022/0379634 A1
(43) Pub. Date: Dec. 1, 2022

(54) MEDIA ROLL SUPPORTS

(71) Applicant: HEWLETT-PACKARD DEVELOPMENT COMPANY, L.P., Spring, TX (US)

(72) Inventors: Joan Marti Velasco Figueras, Sant Cugat del Valles (ES); Martin Urrutia Nebreda, Sant Cugat del Valles (ES); Lluis Valles Casanova, Sant Cugat del Valles (ES)

(73) Assignee: HEWLETT-PACKARD DEVELOPMENT COMPANY, L.P., Spring, TX (US)

(21) Appl. No.: 17/774,969

(22) PCT Filed: Feb. 28, 2020
(86) PCT No.: PCT/US2020/020268

§ 371 Date: May 6, 2022

(51) Int. Cl. B41J 11/04

(52) U.S. Cl. CPC B41J 11/04

(57) ABSTRACT

According to an example, a media roll support may comprise a sliding element movable along a guide, a hub to receive the media roll and a coupling plate. The hub may comprise an elastic element biased towards a first side of the media roll. The coupling plate may be attached to the hub and to the sliding element. Upon holding the media roll, a deformation of the elastic element may tilt the sliding element. The tilting of the sliding element may lock the sliding element movement, thereby preventing its movement.

### BACKGROUND

Media rolls can have different sizes in length and width. In order to support the media rolls within a range of sizes, configurable support devices are used. These configurable support devices include a pair of hubs to hold the media roll between them, thereby enabling to set a width corresponding to the media roll. It is hereby disclosed support devices and systems in which the distance between hubs can be adapted to fit the size of the media roll.

### BRIEF DESCRIPTION OF DRAWINGS

Features of the present disclosure are illustrated by way of example and are not limited in the following figure(s), in which like numerals indicate like elements, in which:

FIG. 1 shows a support to hold a media roll, according to an example of the present disclosure;

FIG. 2 shows a side view of the sliding element of the support of FIG. 1;

FIG. 3 shows another example of sliding element comprising a first aperture and a second aperture;

FIG. 4A shows a detailed view of the first aperture of the sliding element of FIG. 3;

FIG. 4B shows a detailed view of the second aperture of the sliding element of FIG. 3;

FIG. 5 shows a schematic view a system to support a media roll, according to an example of the present disclosure;

FIG. 6 shows a system comprising a guide, a fix support, and a movable support, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are examples of devices and systems which may be used to configure a distance between hubs. Hence, different examples of devices and systems are described.

Printing systems may use media rolls having a large variety of sizes. Media rolls may have different widths, lengths or even thicknesses. In order to support several types of media rolls, media roll supports having a configurable distance have been developed. The configurable distance may be set so that the media roll is supported by its two sides and braking or stopping elements may be provided as to improve safety and reliability of the printer. Since such braking or stopping elements within the support can add complexity to the printing system, mechanical-based alternatives that enable to configure a distance have been developed.

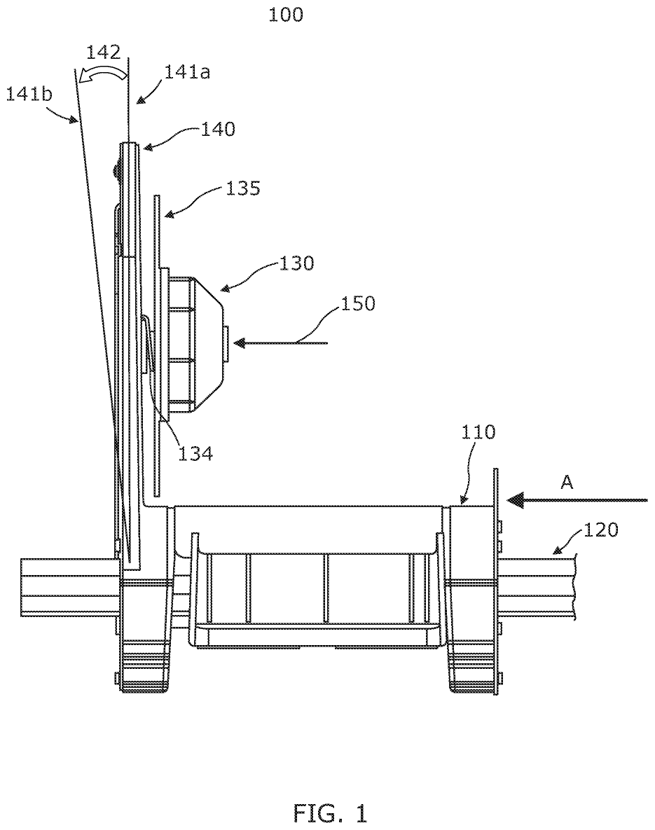

Referring now to FIG. 1, a media roll support 100 to hold a media roll is shown. The support 100 comprises a sliding element 110, a hub 130, and a coupling plate 140. The sliding element 110 is provided with an aperture surrounding a guide 120, and therefore, the sliding element 110 is movable along the guide 120. The coupling plate 140 is attached to the hub 130 and the sliding element 110.

Further, the hub 130 is positioned so that it contacts a first side of the media roll, in particular, a longitudinal edge of the media roll. In some examples, the hub 130 is alternatively referred as roll hub. An elastic element 134 is provided within the hub 130. In an example, the elastic element 134 may be biased towards the media roll, i.e., biased in an axial direction of the support 100. In the example of FIG. 1, the elastic element 134 is coupled to the hub 130 and to the coupling plate 140, however, other examples may envisage other alternatives within the scope of protection of the present application.

Examples of elastic elements may comprise, amongst others, springs, gas canisters, or any element capable of recovering size and shape after a deformation, for example, a deformation caused by the process transmitted forces.

Upon holding the media roll, the sliding element 110 is moved towards the media roll until the elastic element 134 is deformed, the deformation tilts the support 100 as will be explained in the foregoing. The tilting of the sliding element 110 may lock the sliding element 110, thereby preventing its movement. In the example of FIG. 1, a force 150 towards the hub 130 simulates the presence of the media roll. A first reference line 141a shows a configuration of the coupling plate 140 when the sliding element 110 is straight. The deformation of the elastic element 134 may exert a reaction force against the coupling plate 140, the reaction force causes the coupling plate 140 to tilt to a configuration of the coupling plate 140 represented by a second reference line 141b in which the coupling plate 140 is tilted.

A tilting 142 may be defined as the difference between the first reference line 141a and the second reference line 141b. The tilting 142 locks the sliding element 110, and thereby, prevents its movement along the guide 120. The tilting 142 causes the sliding element 110 to contact the guide 120 in several locations. The media roll support 100 may remain locked until the tilting 142 of the sliding element 110 is reduced. The tilting 142 may be reduced by applying a counterforce on the sliding element 110 in parallel direction to the force 150. The counterforce may balance the torque generated by the force 150 so that the movement of the sliding element 110 is unlocked. Other locations and/or directions for the counterforce may be possible, for instance on the media roll support 100 in an axial direction opposed to the force 150. In some examples, the sliding element 110 is movable when the coupling plate 140 is straight and the sliding element 110 is blocked when the coupling plate 140 is tilted. In other examples, the first reference line 141a may refer to a straight position of the coupling plate 140 and the second reference line 141b may refer to a tilted position of the coupling plate 140.

As shown in FIG. 1, the media roll support 100 may further comprise a stopper 135 attached to the hub 130 to reduce media roll movements in an axial direction. However, in other examples, the support 100 may not comprise the stopper 135. In an example, the stopper 135 may comprise a dimension which substantially spans the media roll. In another example, the stopper 135 may span at least half of the media roll. In other examples, the stopper 135 has a dimension that substantially spans the media roll. In the example of FIG. 1, the stopper 135 has a round shape, however, other shapes such as square shape or rectangular shape may also be possible.

In some examples, the media roll support 100 may further comprise a fix hub to receive the media roll, wherein the fix hub is positioned in a second side of the media roll so that the media roll support and the fix hub support the media roll. The second side may be alternatively referred to as opposite side to the first side. In use, the support 100 and the fix hub are separated by a distance associated to the length of the media roll. The fix hub may be coupled to a fix support. The fix support may further comprise a coupling plate attached to the guide and to the fix hub.

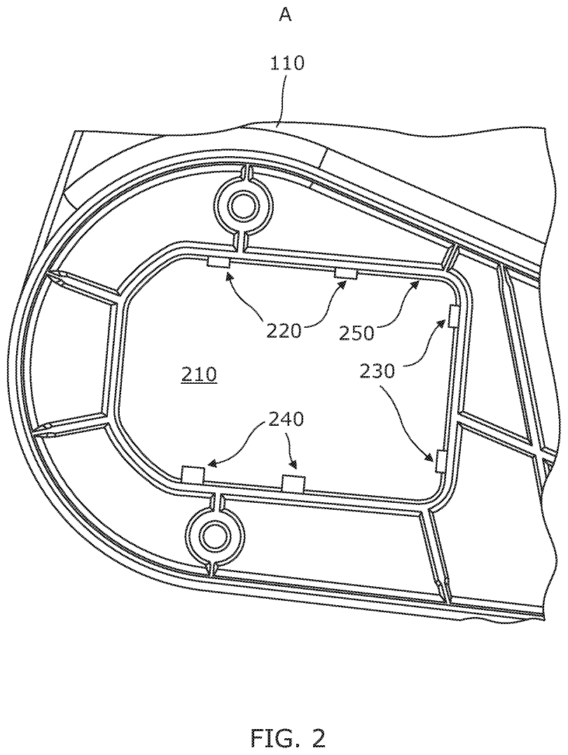

Referring now to FIG. 2, a side view of the sliding element 110 of the media roll support 100 is shown. The sliding element 110 comprises an aperture 210 and a series of datums. The sliding element 110 may partially enclose the guide 120 so that the sliding element 110 is movable along the guide 120. The aperture 210 is to receive the guide 120 so that the sliding element 110 is movable along the guide 120. In an example, the aperture 210 may comprise other shapes.

In the example represented in FIG. 2, the aperture 210 has a substantially rectangular shape in which some of its corners are rounded. However, other alternative shapes may be possible, such as a round shape. The series of datums comprise a first set of datums 220, a second set of datums 230, and a third set of datums 240, wherein the sets of datums are disposed to prevent the sliding element movement when the tilting of the sliding element exceeds a determined threshold. However, in other examples the series of datums may comprise different number of sets and/or distributions.

The datums may have different shapes and/or positions depending on their position along the length of the aperture 210. In some examples, the datum heights, the datum widths, and/or their angular position with respect to the guide may be different along the sliding element 110. In an example, the first set of datums 220 within a first portion of the aperture 210 may have a greater height than the third set of datums 240 positioned in a second portion. In other examples, the set of datums within the first portion of the aperture 210 have a different angular distribution from the set of datums within the second portion. In some examples, the first portion of the aperture 210 and the second portion of the aperture 210 correspond to a distal portion and a proximal portion, respectively. In a further embodiment, the sets of datums may have different friction coefficient with respect to each other, e.g. the third set of datums 240 having a friction coefficient greater than the first set of datums 220.

In an example, the series of datums have a friction coefficient greater than a friction coefficient of a surface 250. In other examples, the datums may be elements protruding from the surface 250 of sliding element 110 towards the aperture 210.

According to some examples, the media roll support comprises a locking state and an unlocking state. The unlocking state may refer to a state in which the sliding element 110 is movable along the guide and the locking state my refer to a state in which the sliding element movement is prevented. During the locking state of the media roll support, i.e., when the sliding element 110 is tilted and, therefore, having and inclination with respect to the guide, the series of datums contact the guide thereby preventing the movement of the sliding element 110 along the guide. A change from the unlocking state to the locking state occurs when the sliding element is tilted over a tilt threshold. In a further example, the tilting may cause the datums to contact opposite sides of the guide so that the sliding element movement along the guide is locked by datums contacting the guide in two different angular positions.

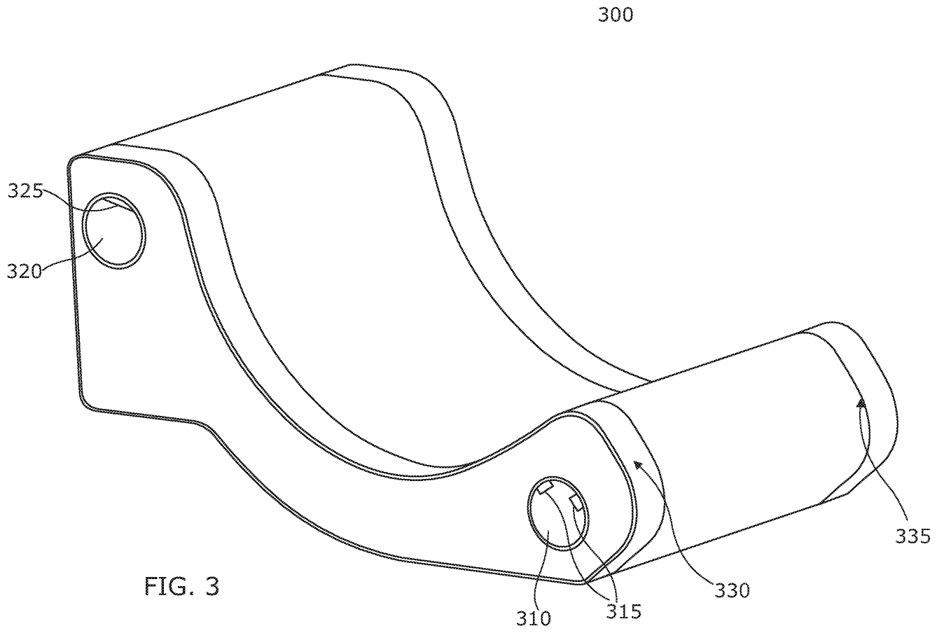

Referring now to FIG. 3, another embodiment of a sliding element 300 is disclosed. In the example of FIG. 3, the sliding element 300 comprises a first aperture 310 and a second aperture 320. A first set of datums 315 is provided within the first aperture 310 and a second set of datums 325 is provided within the second aperture 320. In an example, the first set of datums 315 and the second set of datums 325 may be different between one another, e.g., their angular positions along the sliding element 300 may be different. In a further example, in a first portion 330 of the aperture 310, the first set of datums 315 may be positioned to contact a top face of the guide, meanwhile in a second portion 335 of the aperture 310 the datums 315 may be positioned so that to contact a bottom face of the guide during a locking of the sliding element movement. In the example of FIG. 3, the sliding element 300 has two round-shape apertures, however, it should be understood that other examples may have a different number of apertures and/or shapes.

The sliding element 300 may be attached to the coupling plate (not shown in FIG. 3) so that a force exerted on a hub is transferred to the coupling plate and the coupling plate transfers it to the sliding element 300. For example, a hub, upon holding a media roll, may cause an elastic element comprised within the hub to be deformed, thereby causing a reaction force being exerted on the coupling plate. The reaction force may tilt the coupling plate, and consequently, the sliding element 300. The tilting of the sliding element 300 may lock the sliding element, preventing its movement.

In other examples the elastic element may be a biasing element, e.g. a spring-like element wherein the deformation is a contraction on the element. In this case, the elastic element may be contracted upon holding the media roll, wherein the contraction tilts the coupling plate, and consequently, the sliding element 300.

When the elastic element or the biasing element is contracted may be referred to as a contracted state. Also, the state in which the elastic element or the biasing element is not contracted may be referred to as an expanded state. The elastic element or the biasing element may exert different reaction forces depending on its state. During the expanded state, the reaction force exerted by the elastic element to the coupling plate is not sufficient to tilt the sliding element, and thereby, the sliding element is movable along the guide. Instead, during the contracted state, the reaction force exerted by the elastic element to the coupling plate tilts the sliding element, thereby locking the sliding element movement along the guide. In other examples, the elastic element states may be associated to the deformation of the elastic element. A deformed state may be used to refer to the deformation of the elastic element and an original state may be used to refer to the non-deformation of the elastic element.

In other examples, the state of the media roll support may be associated the elastic element state of, i.e., the media roll support has an unlocking state for the media roll support during the expanded state of the elastic element; and, furthermore, the media roll support has a locking state for the media roll support during the contracted state of the elastic element. In further examples, the expanded state of the elastic element corresponds to a sliding element state in which is the sliding element is movable and the contracted state of the elastic element corresponds to the sliding element state in which the sliding element is static.

In another example, while in the locking state of the media roll support, the sliding element and the guide contact opposite sides of the guide, so that the movement of the sliding element is prevented.

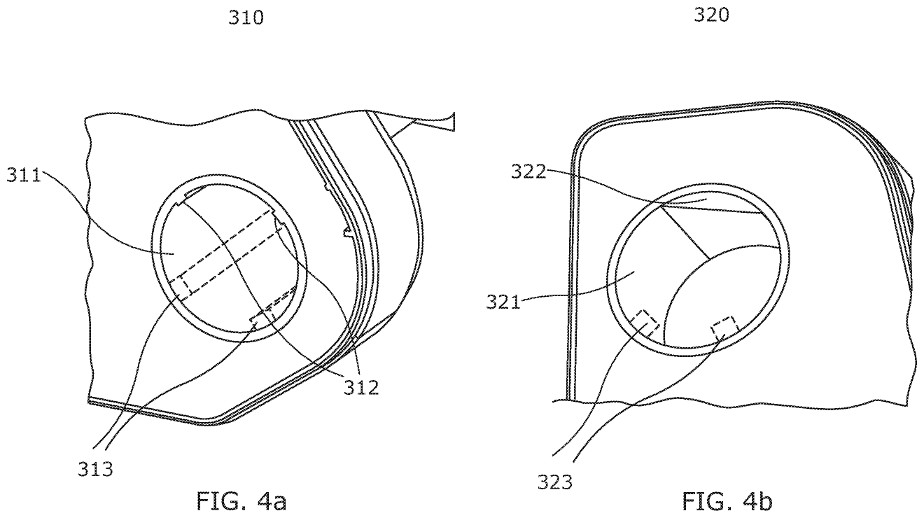

Referring now to FIGS. 4A and 4B, the first aperture 310 and the second aperture 320 of the sliding element 300 are shown. As previously explained in reference to the FIG. 3, the first aperture 310 comprises a surface 311 and datums 312. The datums 312 may change its angular position along the aperture 311. A side of the sliding element in which the hub is comprised may be referred as a distal side. A side opposed to the distal portion may be referred as proximal side. A distal portion may be defined for a segment of the aperture comprised within the distal side. A proximal portion may be defined for a segment of the aperture comprised within the proximal side.

In the example of FIG. 4A, the proximal portion corresponds to a segment of the aperture next to the edge of the first aperture 310. Therefore, the distal portion corresponds to a segment of the aperture next to the edge of the aperture within an opposite side of the sliding element. In reference to FIG. 3, the first portion 330 may be the proximal portion and the second portion 335 may be the distal portion. Within a proximal portion, the datums 312 may contact the guide in the top face. Within the distal portion, the datums 313 may contact the guide in the bottom face. For illustrative purposes, the datums 313 have been indicated with dashed lines along with the datums 312. However, it should be noted that the datums 313 correspond to the distal portion of the aperture 310 and the datums 312 correspond to the proximal portion of the aperture 310.

Referring now to FIG. 4B, the second aperture 320 is shown. The second aperture 320 comprises a surface 321 and a datum 322. The datum 322 is comprised within the proximal portion of the sliding element 300. Meanwhile, the datums 312 of the first aperture 310 comprise two protruding elements, the datum 322 of the second aperture 320 consists of a flat surface protruding from the surface 321. The datum 322 may change physical characteristics along the sliding element, as previously explained in the description. The datums 323 are comprised within the distal portion of the sliding element 300. Dashed lines have been used to illustrate the difference between the proximal portion of the aperture and the distal portion of the aperture.

According to some examples, a system to support a media roll comprises a guide, a fix support, and a movable support. The movable support may correspond to one of the examples described from FIG. 1 to FIG. 4B. The movable support may comprise a coupling plate, a movable hub, and a sliding element. Upon a force is applied to the movable hub towards the coupling plate, the elastic element comprised within the movable hub may deform. The deformation of the elastic element triggers a reaction force on the coupling plate that may tilt the sliding element of the movable support. The tilting of the sliding element may lock the movement of the movable support. However, the deformation of the elastic element may be caused by other conditions, for instance, the presence of a media roll between the fix support and the movable support. In an example, the media roll reception causes the deformation of the elastic element. In other examples, the deformation of the elastic element may result in a contraction of the elastic element. The contraction may exert the reaction force that tilts the coupling plate upon holding a media roll.

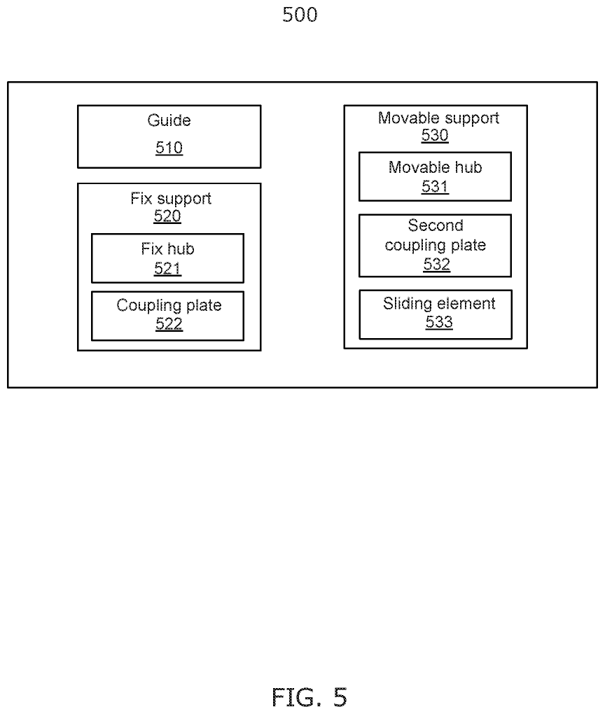

Referring now to FIG. 5, a system 500 to support a media roll is shown. The system 500 may be used within a printing system. The system 500 comprises a guide 510, a fix support 520, and a movable support 530. The fix support 520 comprises a fix hub 521 and a coupling plate 522. The fix hub 521 is rotatable about an axis and the fix hub 521 may receive a first side of the media roll. The coupling plate 522 may be attached to the guide 510 and to the fix hub 521. The movable support 530 may comprise a movable hub 531, a second coupling plate 532, and a sliding element 533. The sliding element 533 is movable along the guide 510 and may correspond to one of the examples previously explained in the description. The movable hub 531 is rotatable about the axis and may receive a second side of the media roll. In FIG. 5, the movable hub 531 comprises an elastic element which is contractible. Upon the media roll is positioned within the fix hub 521 and the movable hub 531, the elastic element is deformed, thereby exerting a reaction force towards the second coupling plate 532. In an example, the elastic element may be a spring and the deformation may cause a contraction. However, other alternatives such as biasing elements may be used.

In some examples, the sliding element 533 slides over the guide 510, wherein the sliding element comprises an aperture having a series of protruding elements. The series of protruding elements may be alternatively referred as datums. The series of protruding elements may have a distribution, wherein the distribution can refer to an angular positioning of the protruding elements. As previously described in the description, the protruding elements may have different friction coefficients with respect to each other and/or to the surface of the aperture. In an example, a friction coefficient of the protruding elements is greater than a friction coefficient of the aperture.

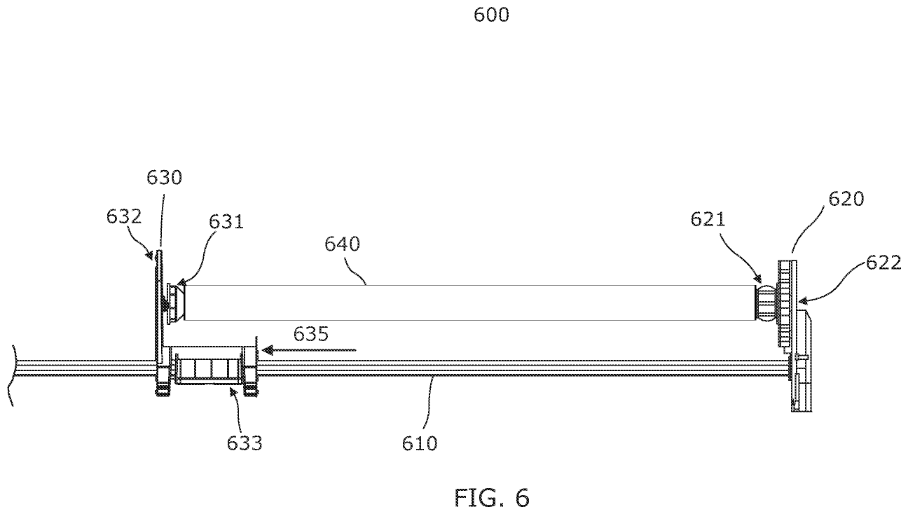

Referring now to FIG. 6, a system 600 comprising a guide 610, a fix support 620, a movable support 630, and a media roll 640 is shown. The system 600 receives the media roll 640 between the fix support 620 and the movable support 630. The fix support 620 comprises a fix hub 621 and a coupling plate 622. As previously explained, the movable support 630 may comprise a movable hub 631, a second coupling plate 632 and a sliding element 633. The sliding element 633 slides over the guide 610, and hence, the distance between the fix hub 621 and the movable hub 631 can be configured. The distance between the hubs may be adjusted so that the media roll 640 can be inserted. The fix hub 621 contacts a first side of the media roll 640 and the movable hub 631 contacts a second side of the media roll 640. The movable hub 631 comprises an elastic element biased towards the fix support 620, i.e., in an axial direction. In other examples, the elastic element may be replaced for a biasing element deformable in the axial direction. In the example shown in FIG. 6, the movable hub does not comprise a stopper having a dimension which substantially spans the media roll 640, however, in other examples the movable support 630 may further comprise the stopper previously described in reference to other examples.

Upon an axial force is applied against the movable hub 631, the elastic element is deformed. The deformation of the elastic element exerts a reaction force towards the second coupling plate 622. The reaction force is transmitted to the sliding element 633. Since an aperture is provided between the sliding element 633 and the guide 610, the sliding element 633 may tilt as a result of the force applied to the movable hub 631, as explained in FIG. 1. The tilting of the sliding element may lock the sliding element, thereby preventing the movement of the movable support 630.

For releasing the locking of the sliding element 633, a counterforce 635 may be applied to the movable support 630. In an example, the counterforce 635 may be a force that reduces the tilting of the sliding element 633 to a straight position, as previously explained in the description. The counterforce 635 reduces the reaction force applied to the second coupling plate 622, and hence, the elastic element expands. The sliding element movement is unlocked when the force applied to the movable hub 631 is released.

However, in the example of FIG. 6, the force that tilts the sliding element 633 is associated to the presence of the media roll 640. The media roll 640 may push the movable hub 631 towards the second coupling plate 632, and as a result of the elastic element may deform, wherein the deformation of the elastic element exerts a reaction force that tilts the second coupling plate 632. As a result of the media roll 640 presence between fix hub 621 and the movable hub 631, the sliding element 633 is tilted. The tilting of the sliding element locks the movement of the movable support 630 along the guide 610. In order to unlock the movement of the movable support 630, the counterforce 635 may be applied to the sliding element 633 so that to separate the movable hub 631 from the media roll 640. The counterforce 635 reduces the tilting of the sliding element 633, and thereby, the sliding element 633 becomes movable. In other examples, other locations and/or directions for the counterforce 635 may be possible, for instance in an axial direction at an external surface of the movable support 630 so that the torque generated by the presence of the media roll 640 is balanced. In other examples, the locking of the sliding element 632 may be associated to the tilting of the sliding element 632, wherein the tilting is caused by a contraction of the elastic element. The contraction may occur upon holding a media roll and the elastic element may be, for instance, a spring element.

During the description, example implementations have been described comprising the following feature sets:

Feature set 1: A media roll support comprising: a sliding element movable along a guide; a hub to receive a media roll, the hub comprising an elastic element biased towards a first side of the media roll; and, a coupling plate attached to the hub and the sliding element, wherein upon holding the media roll the elastic element is deformed, wherein the deformation tilts the sliding element, wherein the tilting of the sliding element locks the sliding element preventing its movement.

Feature set 2: A support comprising the feature set 1, wherein the sliding element comprises an aperture enclosing the guide, wherein the aperture comprises a series of datums to contact the guide, wherein the datums are elements protruding from the sliding element in a direction towards the aperture.

Feature set 3: A support comprising any of the feature sets 1 to 2, wherein the aperture comprises a distal portion and a proximal portion, wherein the datums within the distal portion are at a different angular position from the datums within the proximal portion.

Feature set 4: A support comprising any of the feature sets 1 to 3, wherein the elastic element is coupled to the hub and the coupling plate.

Feature set 5: A support comprising any of the feature sets 1 to 4 further comprising a stopper attached to the roll hub, the stopper having a dimension that substantially spans the media roll.

Feature set 6: A support comprising any of the feature sets 1 to 5 further comprising a fix hub to receive the media roll, wherein the fix hub is positioned in a second side of the media roll.

Feature set 7: A system to support a media roll, the system comprising: a guide; a fix support comprising: a fix hub rotatable about an axis; a coupling plate attached to the guide and to the fix hub; and, a movable support comprising: a movable hub rotatable about the axis and having an elastic element; a sliding element movable along the guide; a second coupling plate attached to the sliding element and to the movable hub; wherein a force applied to the movable hub towards the second coupling plate causes a deformation of the elastic element that tilts the second coupling plate thereby tilting the sliding element, wherein the tilting of the sliding element locks the movable support.

Feature set 8: A system comprising the feature set 7, wherein the sliding element slides over the guide through an aperture, wherein the aperture comprises a series of protruding elements having a distribution.

Feature set 9: A system comprising any of the feature sets 7 to 8, wherein the series of protruding elements comprise a friction coefficient greater than a friction coefficient of the aperture.

Feature set 10: A system comprising any of the feature set 7 to 9, wherein the system is to receive a media roll between the fix hub and the movable hub, wherein the media roll reception causes the deformation of the elastic element.

Feature set 11: A system comprising any of the feature sets 7 to 10, wherein the elastic element is coupled to the second coupling plate and the movable hub, wherein the elastic element is a biasing element and the deformation is a contraction.

Feature set 12: A support device having an unlocking state and a locking state, the device comprising: a sliding element movable along a guide; a coupling plate interconnecting the sliding element and a roll hub; and, the roll hub comprising a biasing element deformable in an axial direction, wherein a force exerted to the roll hub towards the coupling plate causes a deformation, wherein in the unlocking state the sliding element is movable along the guide and in the locking state the sliding element is static, wherein in the locking state the force exerted to the roll hub tilts the sliding element and changes the sliding element to the locking state.

Feature set 13: A support device comprising the feature set 12, wherein the sliding element comprises an aperture that encloses the guide, wherein a series of protruding elements are located on the aperture.

Feature set 14: A support device comprising any of the feature sets 12 to 13, wherein during the locking state the sliding element and the guide contact on opposite sides of the guide.

Feature set 15: A support device comprising any of the feature sets 12 to 14, wherein the biasing element comprises a deformed state and an original state, wherein the locking state of the support device corresponds to the contracted state and the unlocking state corresponds to the expanded state.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

1. A media roll support comprising:
a sliding element movable along a guide;
a hub to receive a media roll, the hub comprising an elastic element biased towards a first side of the media roll; and,
a coupling plate attached to the hub and the sliding element,
wherein upon holding the media roll the elastic element is deformed, wherein the deformation tilts the sliding element, wherein the tilting of the sliding element locks the sliding element preventing its movement.

2. A device as claimed in claim 1 wherein the sliding element comprises an aperture enclosing the guide, wherein the aperture comprises a series of datums to contact the guide, wherein the datums are elements protruding from the sliding element in a direction towards the aperture.

3. A device as claimed in claim 2, wherein the aperture comprises a distal portion and a proximal portion, wherein the datums within the distal portion are at a different angular position from the datums within the proximal portion.

4. A device as claimed in claim 1, wherein the elastic element is coupled to the hub and the coupling plate.

5. A device as claimed in claim 1 further comprising a stopper attached to the roll hub, the stopper having a dimension that substantially spans the media roll.

6. A device as claimed in claim 1 further comprising a fix hub to receive the media roll, wherein the fix hub is positioned in a second side of the media roll.

7. A system to support a media roll, the system comprising:
a guide;
a fix support comprising:
a fix hub rotatable about an axis;
a coupling plate 522 attached to the guide and to the fix hub; and,
a movable support comprising:
a movable hub rotatable about the axis and having an elastic element;
a sliding element movable along the guide;
a second coupling plate attached to the sliding element and to the movable hub;
wherein a force applied to the movable hub towards the second coupling plate causes a deformation of the elastic element that tilts the second coupling plate thereby tilting the sliding element, wherein the tilting of the sliding element locks the movable support.

8. A system as claimed in claim 7, wherein the sliding element slides over the guide through an aperture, wherein the aperture comprises a series of protruding elements having a distribution.

9. A system as claimed in claim 8, wherein the series of protruding elements have a friction coefficient greater than a friction coefficient of the aperture.

10. A system as claimed in claim 7, wherein the system is to receive a media roll between the fix hub and the movable hub, wherein the media roll reception causes the deformation of the elastic element.

11. A system as claimed in claim 7, wherein the elastic element is coupled to the second coupling plate and the movable hub, wherein the elastic element is a biasing element and the deformation is a contraction.

12. A support device having an unlocking state and a locking state, the device comprising:
a sliding element movable along a guide;
a coupling plate interconnecting the sliding element and a roll hub; and,
the roll hub comprising a biasing element deformable in an axial direction, wherein a force exerted to the roll hub towards the coupling plate causes a deformation,
wherein in the unlocking state the sliding element is movable along the guide and in the locking state the sliding element is static, wherein in the locking state the force exerted to the roll hub tilts the sliding element and changes the sliding element to the locking state.

13. A support device as claimed in claim 12, wherein the sliding element comprises an aperture that encloses the guide, wherein a series of protruding elements are located on the aperture.

14. A support device as claimed in claim 12, wherein during the locking state the sliding element and the guide contact on opposite sides of the guide.

15. A support device as claimed in claim 12, wherein the biasing element comprises a deformed state and an original state, wherein the locking state of the support device corresponds to the contracted state and the unlocking state corresponds to the expanded state.
